(19) United States
(12) Patent Application Publication
(10) Pub. No.: US 2025/0192888 A1
(43) Pub. Date: Jun. 12, 2025

(54) OPTICAL TRANSMISSION SYSTEM AND OPTICAL TRANSMISSION METHOD

(71) Applicant: NIPPON TELEGRAPH AND TELEPHONE CORPORATION, Tokyo (JP)

(72) Inventors: Yuto SAGAE, Musashino-shi, Tokyo (JP); Kazuhide NAKAJIMA, Musashino-shi, Tokyo (JP); Taiji SAKAMOTO, Musashino-shi, Tokyo (JP); Takayoshi MORI, Musashino-shi, Tokyo (JP); Takashi MATSUI, Musashino-shi, Tokyo (JP)

(73) Assignee: NIPPON TELEGRAPH AND TELEPHONE CORPORATION, Tokyo (JP)

(21) Appl. No.: 18/686,215

(22) PCT Filed: Aug. 27, 2021
(86) PCT No.: PCT/JP2021/031586

§ 371 Date: Feb. 23, 2024

(51) Int. Cl. H04B 10/291; G02B 6/02; H04B 10/2507

(52) U.S. Cl. CPC H04B 10/2916; G02B 6/02042; H04B 10/2507

(57) ABSTRACT

The present disclosure relates to an optical transmission system that transmits signal light by using a multi-core optical fiber having two or more cores as transmission paths, the optical transmission system including two or more transmitters that transmit signal light to adjacent cores, in opposite directions, of the cores, and two or more pump light oscillators that inject pump light into the same cores as transmission cores to which the signal light is transmitted of the adjacent cores such that the pump light propagates in the same directions as or directions reverse to the directions of the signal light, and perform distributed Raman amplification of the signal light by using the pump light, in which a signal light gain of the signal light transmitted from the transmitters is set such that a signal intensity ratio to a crosstalk noise intensity leaked from the adjacent transmission cores is high.

### TECHNICAL FIELD

The present disclosure relates to an optical transmission system using a multi-core fiber as a transmission medium.

### BACKGROUND ART

As a large-capacity transmission path technology, a space division multiplexing technology has attracted attention. In multi-core optical fiber transmission, which is one of the core technologies, signal crosstalk (hereinafter, referred to as XT) between cores is known as a limiting factor of transmission capacity increase (refer to, for example, Non Patent Literature 1).

Therefore, a method of designing an optical fiber for controlling signal crosstalk between cores has been proposed (refer to, for example, Non Patent Literatures 2 to 4). A bidirectional communication system in which a transmission is reoriented for each core has been proposed (refer to, for example, Non Patent Literature 5).

### CITATION LIST

### Non Patent Literature

Non Patent Literature 1: P. J. Winzer et al., ECOC Tu5.B.7 (2011)
Non Patent Literature 2: T. Matsui et al., ECOC M.1.D.5 (2019)
Non Patent Literature 3: Y. Sagae et al., IEICE Trans. Commun. E103-B.11 1199 (2020)
Non Patent Literature 4: S. Nozoe et al., ECOC (2017)
Non Patent Literature 5: A. Sano et al., JLT 32. 16. 2771 (2014)

### SUMMARY OF INVENTION

### Technical Problem

Further increase of the transmission capacity causes a problem of further reduction in XT combined with a fiber design or a transmission method.

An object of the present disclosure is to further reduce signal crosstalk between cores in multi-core optical fiber transmission.

### Solution to Problem

The present disclosure proposes an optical transmission system to which distributed Raman amplification in an optical fiber is applied. As a result, the present disclosure controls an XT noise light intensity and realizes low XT.

Specifically, according to an optical transmission system and an optical transmission method of the present disclosure, the optical transmission system that transmits signal light by using a multi-core optical fiber having two or more cores as transmission paths, and includes two or more transmitters that transmit signal light to adjacent cores, in opposite directions, of the cores; and two or more pump light oscillators that inject pump light into the same cores as transmission cores to which the signal light is transmitted of the adjacent cores such that the pump light propagates in the same directions as or directions reverse to the directions of the signal light, and perform distributed Raman amplification of the signal light by using the pump light, in which a signal light gain of the signal light transmitted from the transmitters is set such that a signal intensity ratio to a crosstalk noise intensity leaked from the adjacent transmission cores is high.

### Advantageous Effects of Invention

The present disclosure can further reduce signal crosstalk between cores in multi-core optical fiber transmission. Therefore, according to the present disclosure, an effect of increasing the transmission capacity of the optical transmission system is achievable.

### BRIEF DESCRIPTION OF DRAWINGS

FIG. 1 schematically illustrates a transmission system for improving a signal-to-crosstalk noise intensity ratio by using distributed Raman amplification.

FIG. 2 is a configuration diagram of bidirectional transmission and backward pumping DRA that realizes XT reduction.

FIG. 3 is a multistage configuration diagram of bidirectional transmission and backward pumping DRA that realizes XT reduction.

FIG. 4 is a relay configuration diagram of bidirectional transmission and backward pumping DRA that realizes XT reduction.

FIG. 5 is an example of signal light gain dependency of XT change in bidirectional transmission and backward pumping.

FIG. 6 is an example of transmission distance dependency of a maximum signal light gain that realizes XT reduction in backward pumping.

FIG. 7 is a configuration diagram of bidirectional transmission and forward pumping DRA that realizes XT reduction.

FIG. 8 is a multistage configuration diagram of bidirectional transmission and backward pumping DRA that realizes XT reduction.

FIG. 9 is a configuration diagram of bidirectional transmission and forward pumping DRA that realizes XT reduction.

FIG. 10 illustrates an example of a dependency (transmission distance: 100 km) of an XT reduction amount on a signal light gain.

FIG. 11 illustrates an example of a gain difference dependency (transmission distance: 100 km) of maximum and minimum signal light gains that realize XT reduction.

FIG. 12 illustrates an example of a dependency of an XT reduction amount (transmission distance: 150 km) on a signal light gain where there is a signal light gain difference between cores.

FIG. 13 illustrates an example of a gain difference dependency (transmission distance: 150 km) of maximum and minimum signal light gains that realize XT reduction.

FIG. 14 illustrates an example of a transmission distance dependency of K1.

FIG. 15 illustrates an example of a transmission distance dependency of K2.

FIG. 16 illustrates an example of a transmission distance dependency of K3.

FIG. 17 illustrates an example of a transmission distance dependency of K4.

FIG. 18 illustrates an example of a transmission distance dependency of K5.

FIG. 19 illustrates an example of a transmission distance dependency of a signal light gain for minimizing XT in backward pumping and forward pumping DRA.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be implemented in forms with various modifications and improvements on the basis of the knowledge of those skilled in the art. Constituents having the same reference signs in the present description and the drawings indicate the same constituents.

The present disclosure relates to an optical transmission system (using a multi-core optical fiber) using distributed Raman amplification characterized by the followings.
Signal light is transmitted to adjacent cores in opposite directions by transmitters.
Pump light is injected into the adjacent cores from a pump light oscillator to propagate in the same directions as or directions reverse to the directions of the signal light, and distributed Raman amplification of the signal light is realized.
A signal light gain of the signal light transmitted from the transmitters is designed such that a signal intensity ratio to a crosstalk noise intensity is high.

According to the present disclosure, it is practical to suppress the influence of crosstalk noise and increase the transmission capacity of the optical transmission system.

This will be described below in more detail.

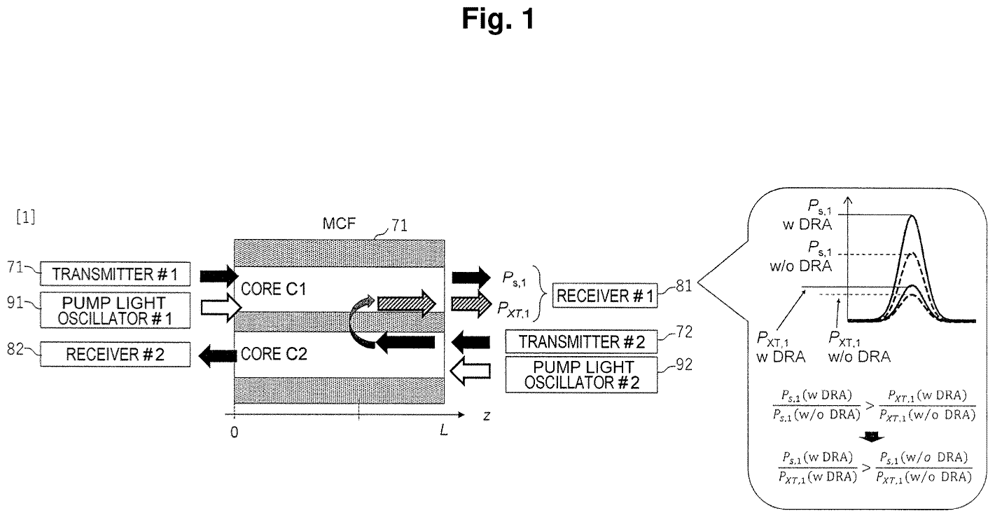

FIG. 1 is a conceptual diagram of an optical transmission system according to the present disclosure. Here, as an example, a system for performing forward pumping distributed Raman amplification (DRA) of signal light in a bidirectional transmission system in which propagation directions of signals are opposite to each other in response to cores C1 and C2, to which the number 1 and the number 2 are assigned respectively, adjacent to each other in an MCF transmission path will be described. One of the signals is transmitted from a transmitter 71 to the core C1, and the other is transmitted from a transmitter 72 to the core C2 to be opposite to the aforementioned signal. As described above, in the present disclosure, the signal light is transmitted in the opposite directions to different cores of the adjacent cores. The signal light in the core C1 is received by a receiver 81, and a received light intensity is Pₛ₁. A portion of the signal light in the core C2 is coupled to the core C1, and crosstalk noise light (XT light) having a light intensity P_{XT1} is detected in the receiver 81.

FIG. 1 illustrates an example in which a pump light oscillator 91 and a pump light oscillator 92 that realize DRA inject pump light in the same directions as those of the signal light in each core. The pump light oscillators 91 and 92 inject the pump light into the same cores as the transmission cores to which the signal light is transmitted of the adjacent cores C1 and C2. Thus, distributed Raman amplification of the signal light using the pump light is performed. Here, the pump light may be injected to propagate in the same directions as those of the signal light, or may be injected to propagate in directions reverse to those of the signal light. Although Psi and P_{XT1} are amplified by the DRA, the amplification at Psi is larger than that at P_{XT1}, and as a result, an intensity ratio Pₛ₁/P_{XT1} of the signal light to XT light is improved.

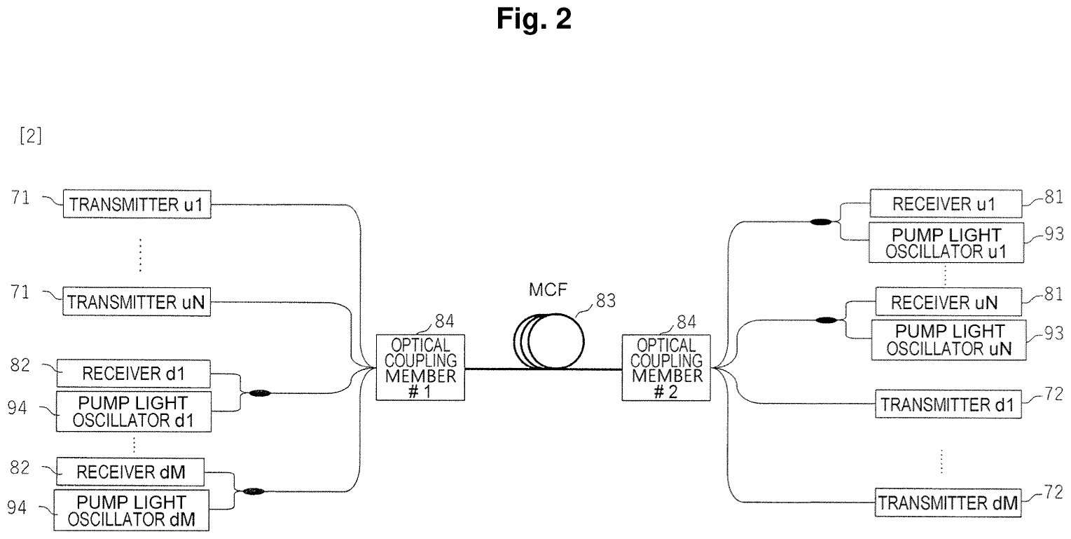

FIG. 2 is a configuration diagram of the optical transmission system according to the present disclosure where an MCF having (N+M) cores is used as a transmission path, as an example. Here, given that n is an integer from 1 to N, it is assumed that cores Cun, to which the number un is assigned each, are not adjacent to each other, and similarly, given that m is an integer from 1 to M, it is assumed that cores Cdm, to which the number dm is assigned each, are not adjacent to each other. Signals generated by transmitters 71u1 to 71uN are respectively transmitted to the cores Cu1 to CuN in an MCF 83 via an optical coupling member 84 #1, and are received by the receivers 81u1 to 81uN via an optical coupling member 84 #2. On the other hand, signals generated by the transmitters 72d1 to 72dM are respectively transmitted to the cores Cd1 to CdM in the MCF 83 via the optical coupling member 84 #2, and are received by the receivers 82d1 to 82dM via the optical coupling member 84 #1.

In this configuration, propagation directions of the signals propagating through the adjacent cores are opposite to each other. Pump light oscillators 93u1 to 93uN and pump light oscillators 94d1 to 94dM transmit pump light in the direction reverse to the signal propagation direction in each core. That is, the signal light propagating through the cores Cu1 to CuN and the cores Cd1 to CdM is amplified by the backward pumping DRA.

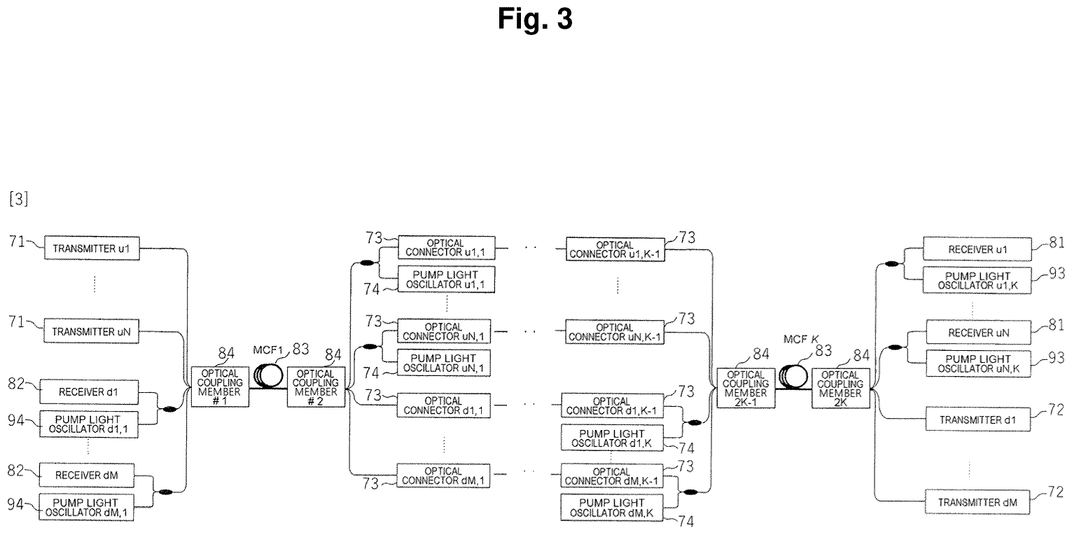

Regarding the optical transmission system according to the present disclosure, FIG. 3 is a configuration diagram of the transmission systems, connected in K stages, each illustrated in FIG. 2 in which an MCF having (N+M) cores is used as a transmission path, as an example here. K is an integer of 2 or more. Given that n and m are integers of 1 to N and 1 to M, the stages are connected via optical connectors 73un,1 to 73un, K−1 and optical connectors 73dm, 1 to 73dm, K−1 each. In each stage, backward pumping DRA of signal light is realized by pump light emitted from the pump light oscillators 74dn,1 to 74dn,K and 74dm,1 to 74dm,K. This configuration is preferable because a planar network is constructable by disposing a router or the like in a connection portion in each stage.

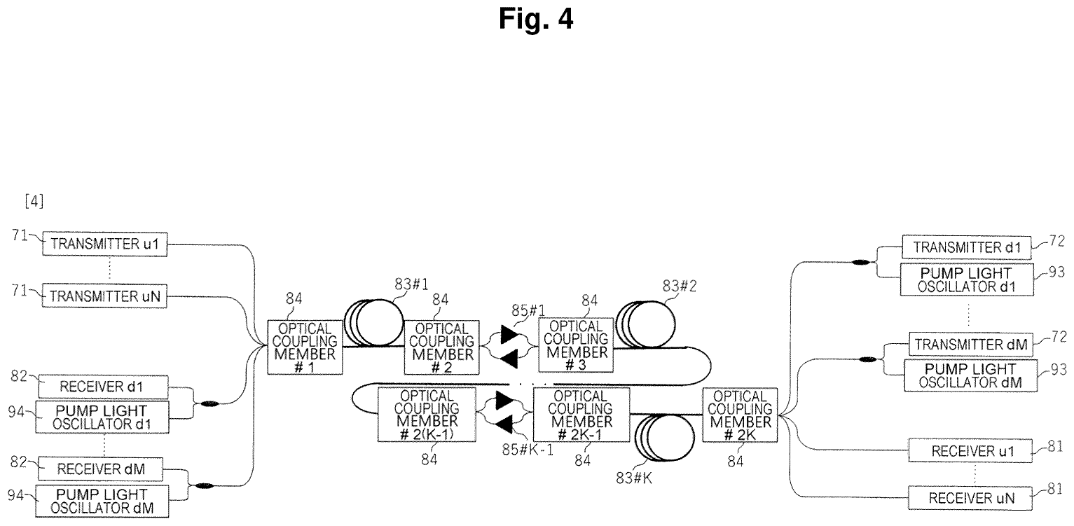

FIG. 4 illustrates an optical transmission system in which K MCFs 83 are connected via K−1 amplification members 85 in the optical transmission system according to the present disclosure. The transmitters 71 and 72, the receivers 81 and 82, and the pump light oscillators 93 and 94 have the configurations illustrated in FIG. 2, and perform the backward pumping DRA of the signal light in the MCFs 83 #1 to 83 #K. Given that k is an integer of 1 to K−1, the MCF 83 #k is connected to the amplification member 85 #k via the optical coupling member 84 #2k and the optical coupling member 84 #2k+1. In this configuration, since a loss caused by the signal light propagating through the MCF is compensated by the amplification member 85, it is practical to cope with a long-distance transmission path, which is preferable.

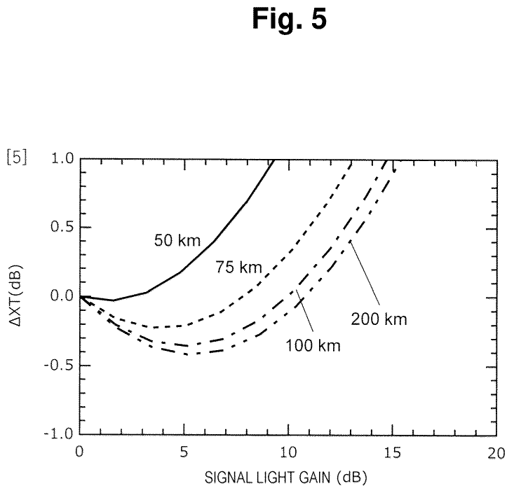

FIG. 5 illustrates a signal light gain dependency of an XT change ΔXT in the configuration illustrated in FIG. 2 in the optical transmission system according to the present disclosure. The XT change is obtained by ΔXT=XT1−XT, where XT with the DRA unapplied is XT0 (dB), and XT with the DRA applied is XT1 (dB). Here, a two-core transmission path is assumed as an example. When the same signal light gain is realized in each core, ΔXT characteristics at transmission distances of 50, 75, 100, and 200 km are respectively indicated by a solid line, a dashed line, a one-dot chain line, and a two-dot chain line. ΔXT is varied by the signal light gain of the backward pumping DRA, and XT reduction is realized in the region of ΔXT<0. These characteristics can also be realized with the device configurations of FIGS. 3 and 4.

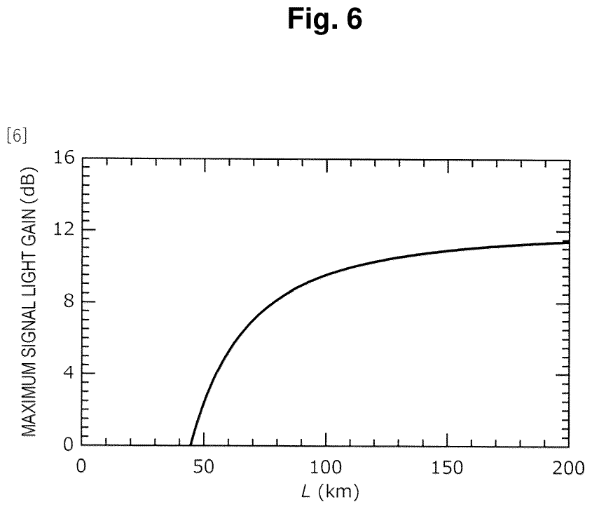

FIG. 6 illustrates a transmission distance dependency of a maximum signal light gain Gₘₐₓ that realizes XT reduction in the configuration illustrated in FIG. 2, that is, realizes ΔXT≤0 in FIG. 3 in the optical transmission system according to the present disclosure. Given that a transmission distance is L, the solid line in the drawing can be expressed by Formula (1).

$$\begin{matrix}( Math . 1 ) & \\ {G}_{max} = 12.1 - 18.1 \times {10}^{3} {L}^{- 1.9} & ( 1 )\end{matrix}$$

As described above, in the configuration illustrated in FIG. 2, the signal light gain Gₛ is set to

Gₛ≤12.1−18.1×10³L^{-1.9},

and thus XT can be reduced.

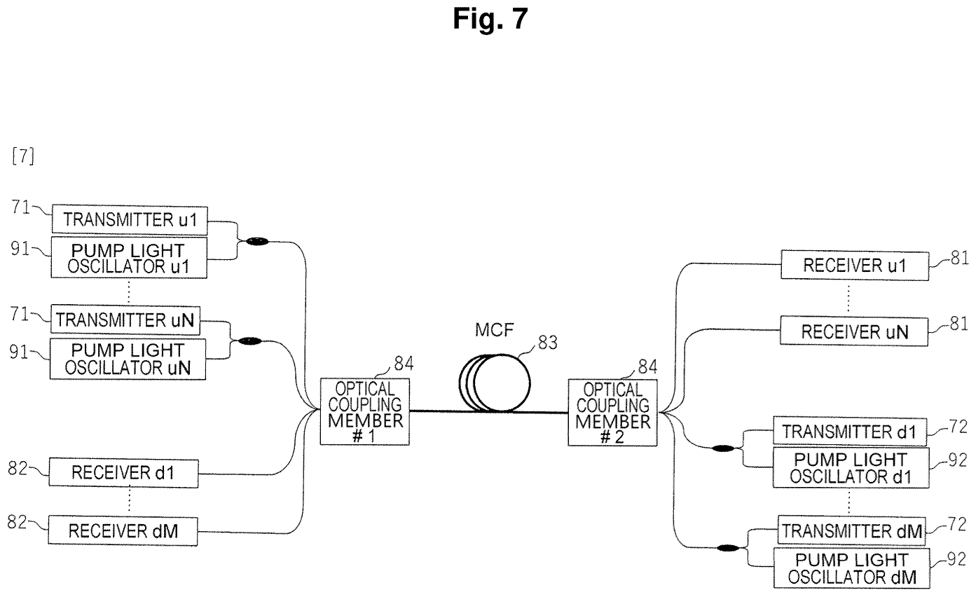

FIG. 7 is a configuration diagram of the optical transmission system according to the present disclosure where an MCF having (N+M) cores is used as a transmission path as an example. Here, given that n is an integer from 1 to N, it is assumed that cores Cun, to which the number un is assigned each, are not adjacent to each other, and similarly, given that m is an integer from 1 to M, it is assumed that cores Cdm, to which the number dm is assigned each, are not adjacent to each other. Signals generated by the transmitters 71u1 to 71uN are respectively transmitted to the cores Cu1 to CuN in the MCF via the optical coupling member 84 #1, and are received by the receivers 81u1 to 81uN via the optical coupling member 84 #2. On the other hand, signals generated by the transmitters 72d1 to 72dM are respectively transmitted to the cores d1 to dM in the MCF via the optical coupling member 84 #2, and are received by the receivers 82d1 to 82dM via the optical coupling member 84 #1.

In this configuration, propagation directions of the signals propagating through the adjacent cores are opposite to each other. The pump light oscillator 91u1 to 91uN and the pump light oscillator 92d1 to 92dM transmit pump light in the same direction as the signal propagation direction in each core. That is, the signal light propagating through the cores Cu1 to CuN and the cores Cd1 to CdM is amplified by the forward pumping DRA. Each of the pump light oscillators 91 and 92 independently determines a pump light intensity and controls an amplification gain of the signal light such that the signal light propagating through each core reaches the receiver with a desired intensity.

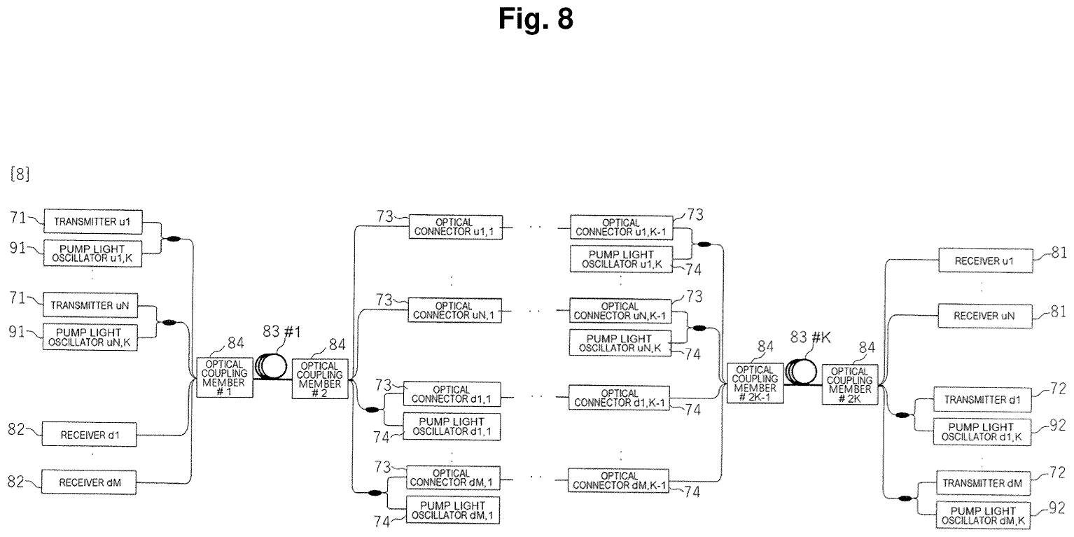

Regarding the optical transmission system according to the present disclosure, FIG. 8 is a configuration diagram of the transmission systems, connected in K stages, each illustrated in FIG. 7 in which an MCF having (N+M) cores is used as a transmission path, as an example here. K is an integer of 2 or more. Given that n and m are integers of 1 to N and 1 to M, the stages are connected via optical connectors 73un, 1 to 73un, K−1 and optical connectors 73dm, 1 to 73dm, K−1 each. In each stage, the signal light propagating through each core is amplified by the forward pumping DRA using the pump light from the pump light oscillators 74dn, 1 to 74dn, K and 74dm, 1 to 74dm,K. This configuration is preferable because a planar network is constructable by disposing a router or the like in a connection portion in each stage.

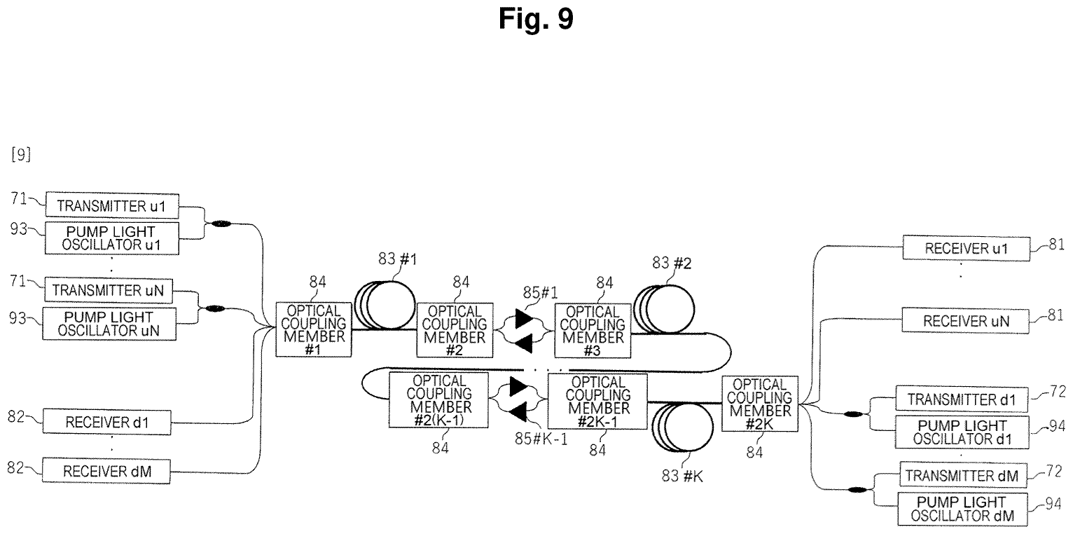

FIG. 9 illustrates an optical transmission system in which K MCFs 83 are connected via K−1 amplification members 85 in the optical transmission system according to the present disclosure. The transmitters 71 and 72, the receivers 81 and 82, and the pump light oscillators 91 and 92 have the configurations illustrated in FIG. 7, and perform forward pumping DRA of the signal light in the MCFs 83 #1 to 83 #K. Given that k is an integer of 1 to K−1, the MCF—83 #k and the MCF—83 #k+1 are connected via the optical coupling member 84 #2k, the optical coupling member 84 #2k+1, and the amplification member 85 #k. In this configuration, since a loss caused by the signal light propagating through the MCF is compensated by the amplification member 85, it is possible to cope with a long-distance transmission path, which is preferable.

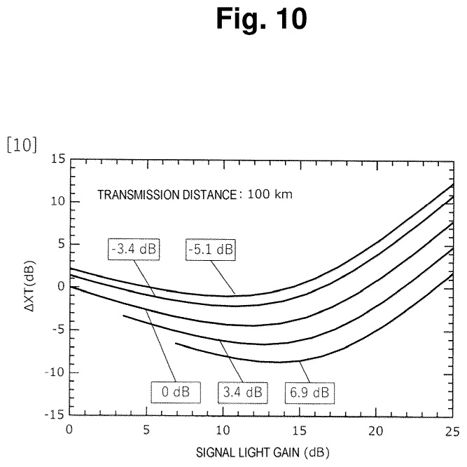

FIG. 10 illustrates a dependency of ΔXT on a signal light gain at a transmission distance of 100 km according to the present disclosure. The individual solid lines indicate results where the difference ΔG of the signal light gain G₁ in the transmission cores to the signal light gain G₂ in the adjacent cores is set to −5.1 dB, −3.4 dB, 0 dB, 3.4 dB, and 6.9 dB. When the signal light gain G₁ in the transmission cores is larger than the signal light gain G₂ in the adjacent cores, i.e., provided ΔG>0, there is a maximum signal light gain that reduces XT, that is, satisfies ΔXT≤0. On the other hand, when the signal light gain G₁ in the transmission cores is smaller than the signal light gain G₂ in the adjacent cores, i.e., provided ΔG<0, there are a minimum value and a maximum value of the signal light gain that satisfy ΔXT≤0.

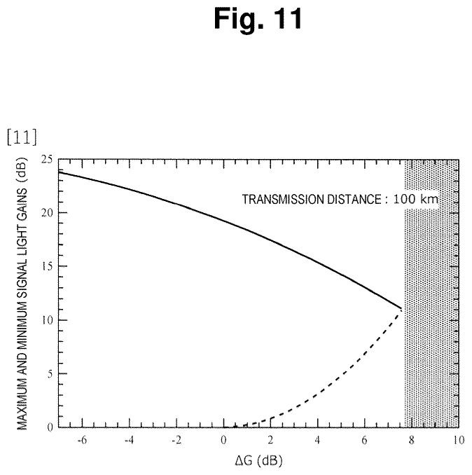

FIG. 11 illustrates a ΔG dependency of the maximum and minimum signal light gains G₁ that realize XT reduction. The solid line represents a maximum signal light gain Gₘₐₓ, and the dashed line represents a minimum signal light gain Gₘᵢₙ. On condition of ΔG>7.6 dB or more (gray), the XT reduction effect cannot be achieved. When the signal light gain is smaller than the solid line in the drawing and larger than the dashed line, XT reduction is realized. Here, the solid line may be expressed by Formula (2), and the dashed line may be expressed by Formula (3).

$${G}_{max} = 19.4 - 0.9 Δ G + 0.03 Δ {G}^{2} \qquad ( 2 )$$

$${G}_{min} = 0.04 Δ G + 0.2 Δ {G}^{2} \qquad ( 3 )$$

Therefore, XT reduction can be realized by setting the following equations at the transmission distance of 100 km:

$$0 \leq {G}_{1} \leq 19.35 - 0.85 Δ G + 0.03 Δ {G}^{2} at Δ G < 7.6 dB , and$$

$$0.04 Δ G + 0.2 Δ {G}^{2} \leq {G}_{1} \leq 1 9.4 - 0.9 Δ G + 0.03 Δ {G}^{2} at 0 \leq Δ G < 7.6 .$$

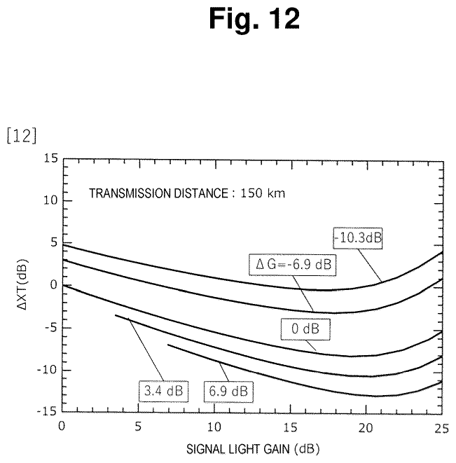

FIG. 12 illustrates a dependency of ΔXT on a signal light gain at a transmission distance of 150 km according to the present disclosure. The individual solid lines indicate results where the difference ΔG of the signal light gain G₁ in the transmission cores to the signal light gain G₂ in the adjacent cores is set to −10.3 dB, −6.9 dB, 0 dB, 3.4 dB, and 6.9 dB. When the signal light gain G₁ in the transmission cores is larger than the signal light gain G₂ in the adjacent cores, i.e., provided ΔG>0, there is a maximum signal light gain that realizes XT reduction, that is, satisfies ΔXT≤0. On the other hand, when the signal light gain G₁ in the transmission cores is smaller than the signal light gain G₂ in the adjacent cores, i.e., provided ΔG<0, there are a minimum value and a maximum value of the signal light gain that satisfy ΔXT≤0.

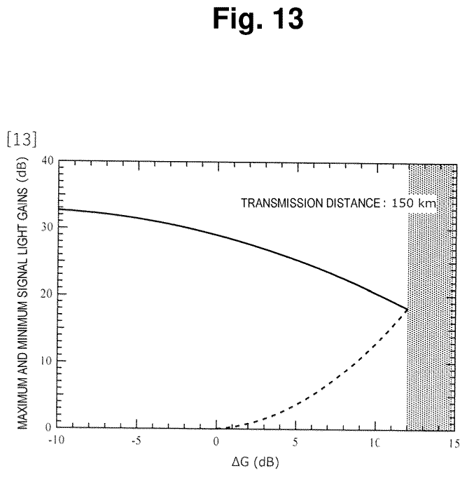

FIG. 13 illustrates a ΔG dependency of the maximum and minimum signal light gains G₁ that realize XT reduction. The solid line represents a maximum signal light gain Gₘₐₓ, and the dashed line represents a minimum signal light gain Gₘᵢₙ. On condition of ΔG>12.0 dB or more (gray), the XT reduction effect cannot be achieved. When the signal light gain is smaller than the solid line in the drawing and larger than the dashed line, XT reduction is realized. Here, the solid line may be expressed by Formula (4), and the dashed line may be expressed by Formula (5).

$${G}_{max} = 2 9. - 0.6 Δ G + 0.02 Δ {G}^{2} \qquad ( 4 )$$

$${G}_{min} = 0.2 Δ G + 0.1 Δ {G}^{2} \qquad ( 5 )$$

Therefore, XT reduction can be realized by setting the following equations at the transmission distance of 150 km:

$$0 \leq {G}_{1} \leq 29 \text{.01} - 0.61 Δ G + 0.02 Δ {G}^{2} at Δ G < 12. dB , and$$

$$0.19 Δ G + 0.11 Δ {G}^{2} \leq {G}_{1} \leq 29 \text{.01} - 0.61 Δ G + 0.02 Δ {G}^{2} at 0 \leq Δ G < 12. .$$

Here, in Formulas (2) and (4) and Formulas (3) and (5), given that coefficients K1(L), K2(L), K3(L), K4(L), and K5(L) depending on the transmission distance L are used, Gₘₐₓ and Gₘᵢₙ are expressed by the following formulas, respectively.

$${G}_{max} = K 1 ( L ) + K 2 ( L ) Δ G + K 3 ( L ) Δ {G}^{2}$$

$${G}_{min} = K 4 ( L ) Δ G + K 5 ( L ) Δ {G}^{2}$$

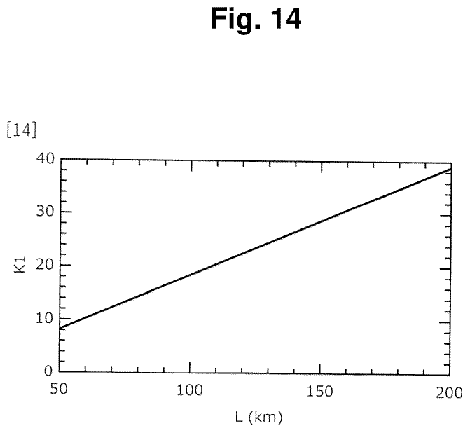

FIG. 14 illustrates an L dependency of K1. The solid line in the drawing may be expressed by Formula (6).

$$\begin{matrix}( Math . 6 ) & \\ K 1 = - 2.0 + 0.2 L & ( 6 )\end{matrix}$$

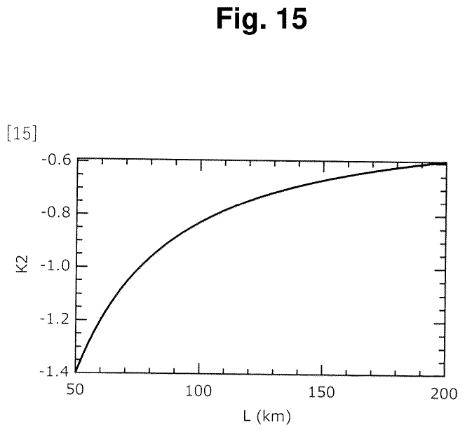

FIG. 15 illustrates an L dependency of K2. The solid line in the drawing may be expressed by Formula (7).

$$\begin{matrix}( Math . 7 ) & \\ K 2 = - 0.4 - 14 \; 0.5 {L}^{- 1.3} & ( 7 )\end{matrix}$$

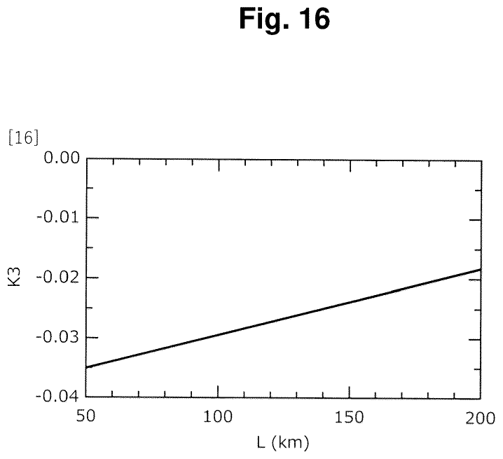

FIG. 16 illustrates an L dependency of K2. The solid line in the drawing may be expressed by Formula (8).

$$\begin{matrix}( Math . 8 ) & \\ K 3 = - 0.04 + 1.1 \times {10}^{- 4} L & ( 8 )\end{matrix}$$

As described above, a maximum signal light gain that realizes the XT reduction may be expressed by the following Formula using ΔG and L.

$$\begin{matrix}( Math . 9 ) & \\ {G}_{max} = - 2.0 + 0 \text{.2} L + ( - 0.4 - 140.5 {L}^{- 1.3} ) Δ G + ( - 0.04 + 1. 1 \times {10}^{- 4} ) Δ {G}^{2} & ( 9 )\end{matrix}$$

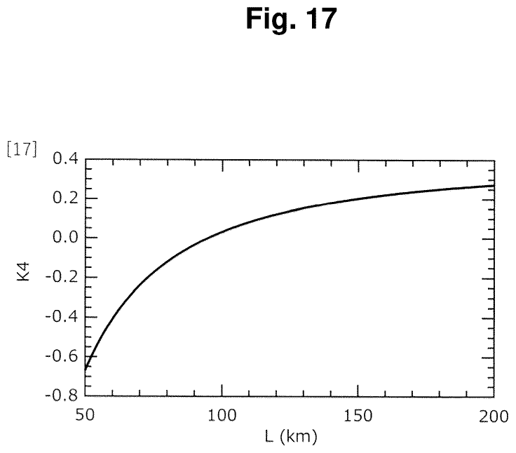

FIG. 17 illustrates an L dependency of K4. The solid line in the drawing may be expressed by Formula (10).

$$\begin{matrix}( Math . 10 ) & \\ K 4 = - 0 \text{.40} - 443.8 {L}^{- 1.5} & ( 10 )\end{matrix}$$

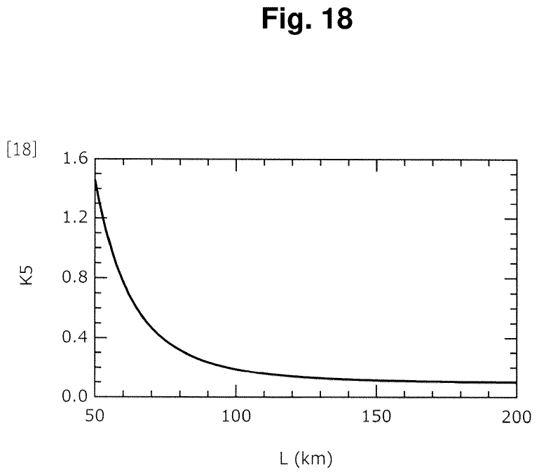

FIG. 18 illustrates an L dependency of K5. The solid line in the drawing may be expressed by Formula (11).

$$\begin{matrix}( Math . 11 ) & \\ K 5 = - 0.1 - 8. \times 1 {0}^{6} {L}^{- 4} & ( 11 )\end{matrix}$$

As described above, the minimum signal light gain that realizes the XT reduction may be expressed by the following Formula using ΔG and L.

$${G}_{min} = ( - 0 \text{.40} - 443. 8 {L}^{- 1.5} ) Δ G + ( - 0.1 - 8. \times 1 {0}^{6} {L}^{- 4} ) Δ {G}^{2}$$

Therefore, the XT reduction effect can be achieved by setting the signal light gain G₁ as follows with respect to ΔG and L:

$${G}_{1} \leq - 2.0 + 0.2 L + ( - 0.4 - 140. 5 {L}^{- 1.3} ) Δ G + ( - 0.04 + 1.1 \times 1 {0}^{- 4} ) Δ {G}^{2}$$

$$and$$

$$( - 0.4 - 443. 8 {L}^{- 1.5} ) Δ G + ( - 0.1 - 8. 0 \times 1 {0}^{6} {L}^{- 4} ) Δ {G}^{2} \leq {G}_{1} provided 0 \leq Δ G .$$

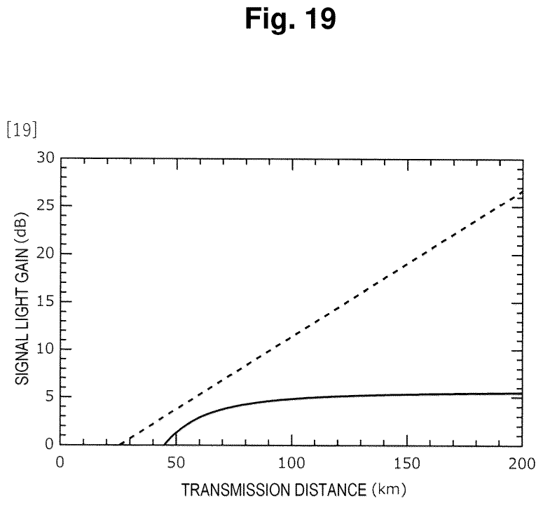

FIG. 19 illustrates a transmission distance dependency of the signal light gain Gₛ that minimizes ΔXT in the configuration in which the backward pumping and the forward pumping DRAs illustrated in FIGS. 2 and 7 are performed in the optical transmission system according to the present disclosure. Here, a two-core transmission path is assumed as an example, and it is assumed that the same signal light gain is realized in each core. The solid line and the dashed line in the drawing indicate the examples of the backward pumping DRA and the forward pumping DRA, and, given that the transmission distance is L, each curve can be expressed by the following formulas (12) and (13).

$$\begin{matrix}( Math . 12 ) & \\ {G}_{s} = 5.6 - 6.2 \times 1 {0}^{4} {L}^{- 2.4} & ( 12 )\end{matrix}$$

$$\begin{matrix}( Math . 13 ) & \\ {G}_{s} = 3.9 - 0.2 L & ( 13 )\end{matrix}$$

The maximum XT reduction effect can be achieved by designing the transmission system enabling the signal light gain expressed by Formulas (12) and (13) to be realized.

### INDUSTRIAL APPLICABILITY

The present disclosure can be applied to the information and communications industry.

### REFERENCE SIGNS LIST

73 Optical connector
74 Pump light oscillator
83 MCF
84 Optical coupling member
85 Optical amplifier
71, 72 Transmitter
81, 82 Receiver
91, 92, 93, 94 Pump light oscillator

1. An optical transmission system that transmits signal light by using a multi-core optical fiber having two or more cores as transmission paths, the optical transmission system comprising:
two or more transmitters that transmit signal light to adjacent cores, in opposite directions, of the cores; and
two or more pump light oscillators that inject pump light into the same cores as transmission cores to which the signal light is transmitted of the adjacent cores such that the pump light propagates in the same directions as or directions reverse to the directions of the signal light, and perform distributed Raman amplification of the signal light by using the pump light,
wherein a signal light gain of the signal light transmitted from the transmitters is set such that a signal intensity ratio to a crosstalk noise intensity leaked from the adjacent transmission cores is high.

2. The optical transmission system according to claim 1, wherein
a signal light gain Gₛ of the signal light satisfies the following formula with respect to a transmission distance L of the adjacent transmission cores:
$${G}_{s} \leq 1 2.1 - 18. 1 \times 1 {0}^{3} {L}^{- 1.9} .$$

3. The optical transmission system according to claim 2, wherein
signal light gains of the signal light in the adjacent transmission cores are G₁ and G₂, and
the signal light gain G₁ satisfies the following formula with respect to a signal light gain difference ΔG, which is a difference of G₁ to G₂, and the transmission distance L:
$${G}_{1} \leq - 2.0 + 0 \text{.2} L + ( - 0.4 - 14 \; 0.5 {L}^{- 1.27} ) Δ G + ( - 0.04 + 1.1 \times 1 {0}^{4} ) Δ {G}^{2}$$
$$and$$
$${G}_{1} \geq ( - 0 \text{.40} - 44 \; 3.8 {L}^{- 1.54} ) Δ G + ( - 0 \text{.10} - 8. \times 1 {0}^{6} {L}^{4} ) Δ {G}^{2} provided Δ G \geq 0 .$$

4. The optical transmission system according to claim 2, wherein the transmitters transmit the signal light with a signal light gain such that a signal intensity ratio to a crosstalk noise intensity leaked from the adjacent transmission cores is maximized.

5. An optical transmission method of transmitting signal light by using a multi-core optical fiber having two or more cores as transmission paths, the optical transmission method comprising:
transmitting, by means of two or more transmitters, signal light to adjacent cores, in opposite directions, of the cores; and
injecting, by means of two or more pump light oscillators, pump light into the same cores as transmission cores to which the signal light is transmitted of the adjacent cores such that the pump light propagates in the same directions as or directions reverse to the directions of the signal light, and performing distributed Raman amplification of the signal light by using the pump light,
wherein a signal light gain of the signal light transmitted from the transmitters is set such that a signal intensity ratio to a crosstalk noise intensity leaked from the adjacent transmission cores is high.
